(19) United States
(12) Patent Application Publication
(10) Pub. No.: US 2022/0132465 A1
(43) Pub. Date: Apr. 28, 2022

(54) METHOD FOR SCHEDULING PAGING IN TELECOMMUNICATION NETWOK

(71) Applicant: VIETTEL GROUP, Ha Noi City (VN)

(72) Inventors: Quang Diep Pham, Chi Linh City (VN); Minh Duc Do, Ha Noi City (VN); Minh Tu Le, Ha Noi City (VN)

(73) Assignee: VIETTEL GROUP, Ha Noi City (VN)

(21) Appl. No.: 17/510,920

(22) Filed: Oct. 26, 2021

(30) Foreign Application Priority Data
Oct. 27, 2020 (VN) 1-2020-06186

(51) Int. Cl. H04W 68/02; H04W 68/06

(52) U.S. Cl. CPC H04W 68/02; H04W 68/06

(57) ABSTRACT

Method for scheduling paging in telecommunication network making the list candidate base station to send paging message. This method based on the Haversine formula to calculate distance between pair of base station from position information (latitude, longitude) and filter by situation: Distance=<Δ*Min (which Δ is 3) to make the list candidate base station for each of base station in list input. This method is useable for the telecommunication system which need to page UE for mobile terminated (MT) service.

### FIELD OF THE INVENTION

Method for scheduling paging in telecommunication network in accordance with the telecommunication systems need to process paging camped user equipment (UE) for mobile terminated (MT) service as: call, downlink data, short message service (sms), multimedia message service (mms). In this case, this method focus is in 4G network but it is also use for 2G, 3G, 5G and next generation network.

### DESCRIPTION

Global System for Mobile Communications (GSM) is a cellular network, which means that mobile phones connect to it by searching for cells. The base station is physical device which makes the coverage area in which service is provided for UE to communicates with the telecommunication network by radio waves through local antenna (FIG. 1). Each base station has one or more cells. Tracking Area (TA) is a logical grouping of cells (FIG. 2), GSM has one or more TA.

UE in GSM network can use the service by camping to a cell of a base station and is located in network base on base station's position and TA. When the system needs to page user equipment, they can process paging on:
Level 1: The last base station that UE used service.
Level 2: All of base station in the last tracking area (TA) that UE used service.
Level 3: All of base station in the system.

To ensure paging success rate (PSR), the common method for scheduling paging as the below:
Method 1: page ascending level: the first times, page with level 1. If UE is not responding, the next times, page by level 2. And the last times, page with level 3 if UE is not responding.
Method 2: only page with level 2 and retry page if UE is not responding.
Method 3: page with level 3 and retry page if UE is not responding.

The base station received paging message from network will send message paging to all of UE in station coverage. All of UE in that coverage listen to the paging message from network and respond to the network if information in message is matched with information in the UE. So that, the UE will lose a little energy to process a message even though the content inside the message is not its own. Therefore, applying method 3 can achieve the best PSR, but the system performance is very high and all of the UE in the network will lose power faster. Applying method 1 is also not good because the system often retries to page UE, therefor PSR is low. Method 2 is often used because the PSR is acceptable and the system performance is not high, the UE doesn't consume too much energy for processing paging message (if the number of base station in TA is not much).

### TECHNICAL BACKGROUND

This method is given to reduce the paging message but still get the high PSR:
i) Initialization
   Input: information of list of base stations managed by the system. Each of the base station includes the information as the below:
      + Base station identify
      + Base station position: Latitude, Longitude
      + Tracking Area
ii) Calculate distance and make the list candidate base station
iii) When page UE
   Determine the last base station and TA that UE used service
   Get the list candidate base station and send paging message to all of its candidates.

### BRIEF DESCRIPTIONS AND DRAWINGS

FIG. 1: Base station and radio connect from UE

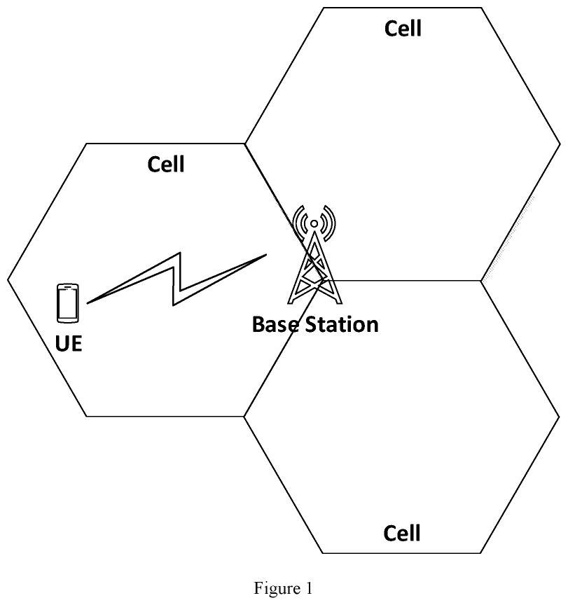

FIG. 2: Tracking Area—Group base station/cells

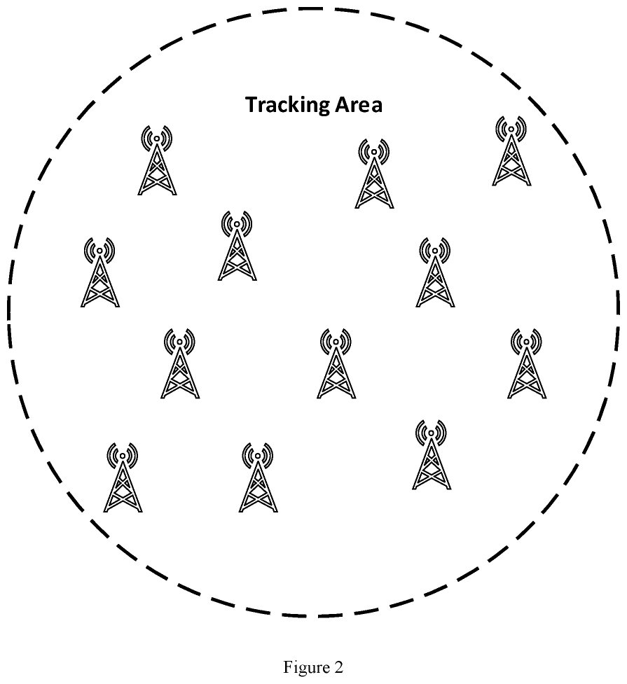

FIG. 3: Flow process

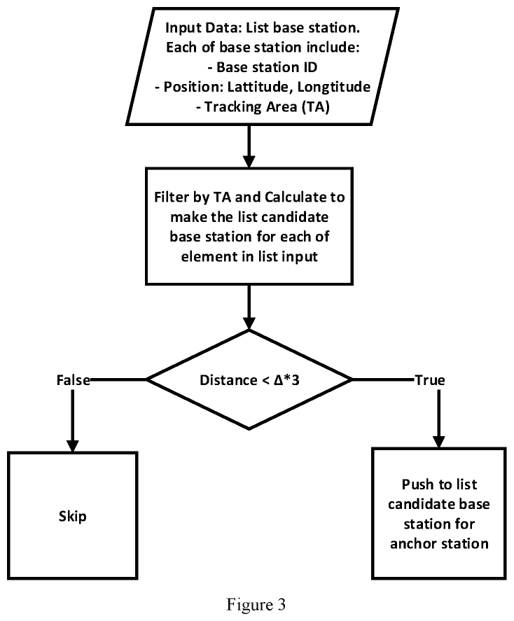

### DETAIL OF INVENTION

This method is described as the below:
i) Initialization:
   Input: information of list of base stations managed by the system (L). Each of the base stations include the information as the below:
      + Base station identify
      + Base station position: Latitude, Longitude
      + Tracking Area
ii) Calculate distance and make the list of candidate base stations
   Each of base station in the list from step i) is the anchor station to calculate distance and make the list candidate base station as the below:
      + Step 1: filter from L to get all of the base stations which have same TA value with anchor station (except anchor station).
      + Step 2: calculate the distance from the anchor station to each of station in filter list in Step 1 by the Haversine formula:

R=6378137 (unit: m,Earth's Radius)
Lat1: Latitude value of anchor station
Lat2: Latitude value of other station
Lon1: Longitude value of anchor station
Lon2: Longitude value of other station

DeltaLon=(Lon2−Lon1)*π/180

DeltaLat=(Lat2−Lat1)*π/180

Lat1Ra=Lat1*π/180

Lat2Ra=Lat2*π/180

A=(sin(DeltaLat/2))\hat{ }2+cos(Lat1)*cos(Lat2)*(sin(DeltaLon/2)\hat{ }2

C=2*a tan(sqrt(A),sqrt(1−A))

Distance=R*C
+ Step 3: Sort all of Distance value from step 2 by increasing order and choose Min is minimum Distance value.
   Set Δ=3.
   Make the candidate base station of anchor station from filter list of step 1 and distance value of step 2 by filter: The base station in filter of step 1 which have distance value with anchor station=<Δ*3.
iii) When need to page UE: determine the last base station that UE used service and get the list candidate base station of it to send paging message

### Application

Using in module to Manage ID of Mobility Management Entity—MME.

Compare between the system using method 2 above and the system apply the inventive method (both systems manage 1 TA including 137 base stations)

| | | | | | | | | S1 |
|---|---|---|---|---|---|---|---|---|
| | | | | RRC | RRC | | S1 | connection |
| | | Number | RRC | connection | connection | S1 | connection | attempt |
| | | of paging | connect | attempt | success | connection | attempt | success |
| Method | Day | message | attempt | success | rate | attempt | success | rate |
| Method | Sep. 14, 2020 | 9054613071 | 37972976 | 37956602 | 0.99956875 | 37956603 | 37933729 | 0.99939736 |
| 2 | | | | | | | | |
| invention | Sep. 21, 2020 | 1273916315 | 39034512 | 39017592 | 0.99956654 | 39015635 | 39007389 | 0.99978865 |

### Effect

Number of paging messages is reduced (˜86% in application case, other case depending on network planning);
Number of message on radio network is also reduced, contributing to power saving for UE;
PSR is not decreased.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed:

1. Method for scheduling paging in telecommunication network, comprising
i) Initialization:
Input: information of list base station managed by the system (L), Each of base station includes the information as the below:
+ Base station identify
+ Base station position: Latitude, Longitude
+ Tracking Area
ii) Calculate distance and make the list candidate base station
Each of base station in the list from step i) is the anchor station to calculate distance and make the list candidate base station of its as the below:
+ Step 1: filter from L to get all of the base station which have same TA value with anchor station (except anchor station);
+ Step 2: calculate the distance from the anchor station to each of station in filter list in Step 1 by the Haversine formula
+ Step 3: Sort all of Distance value from step 2 by order increase and choose Min is minimum Distance value;
Set Δ=3,
Make the candidate base station of anchor station from filter list of step 1 and distance value of step 2 by filter: The base station in filter of step 1 which have distance value with anchor station=<Δ*Min,
iii) When need to page UE: determine the last base station that UE used service and get the list candidate base station of it to send paging message.
